(19) United States
(12) Patent Application Publication
(10) Pub. No.: US 2013/0254417 A1
(43) Pub. Date: Sep. 26, 2013

(54) SYSTEM METHOD DEVICE FOR STREAMING VIDEO

(71) Applicant: Jason Nicholls, (US)

(72) Inventor: Jason Nicholls, (US)

(21) Appl. No.: 13/471,546

(22) Filed: May 15, 2012

Related U.S. Application Data
(60) Provisional application No. 61/685,736, filed on Mar. 21, 2012.

(51) Int. Cl. G06F 15/16

(52) U.S. Cl. 709/231

(57) ABSTRACT

A system for real-time streaming of computer multi-media between a server and a client device. The server intercepts rendered graphics frame and audio for local output, compresses and coverts the graphics to be compatible with the client device display size and compresses the frame for transmission. Further, the application audio is converted to correspond with the audio channel capability of the client and compressed for transmission. The server can modify of the multi-media API on the loading into the server to include the function of buffering and processing the frame data. The client is configured to scale and transform user inputs to match the input range and type for a server application.

### RELATED APPLICATION

This application claims priority under 35 U.S.C. §119(e) of the co-pending U.S. provisional patent application Ser. No. 61/685,736 filed on Mar. 21, 2012, and titled “DEVICE SYSTEM METHOD FOR STREAMING VIDEO.” The provisional patent application Ser. No. 61/685,736 filed on Mar. 21, 2012, and titled “DEVICE SYSTEM AND METHOD FOR STREAMING VIDEO” is hereby incorporated by reference.

### FIELD OF THE INVENTION

This invention relates generally to methods, systems and devices for streaming graphics video frames to and displaying of on a client device. Further, the invention is directed to using an application on a client device where the application was not designed for capable of executing on the client.

### BACKGROUND

Complex computer modeling systems require a high graphic processing capability to generate complex and realistic real-time images. Exemplar of these types of systems includes video games, flight simulators, and molecular modeling. The greater the graphics processing capability, the more realistic the rendering of graphic frames, the faster the frame rates, the lower the delays, and thus the faster response times. Response times can be important in multi-player games.

Personal computers or servers, configured for high performance gaming, can contain graphic cards with tens of graphic cores for fast and detailed rendering of real-time graphic video frames. However, there is a trade-off for this high performance graphics processing. The computer requires more power, is more expensive, and typically the application or game are only available for a small number of platforms and typically are not compatible with tablet and mobile devices.

What is needed are systems, methods, and devices that provide the high end graphic processing capabilities while rendered frames are still able to be displayed and utilized on devices without built in high end graphics processing capabilities or the operating environment to run the application.

### BRIEF DESCRIPTION OF THE DRAWINGS

FIG. 1A is a block diagram of the architecture of a system generating rendered video frame and displaying the rendered frames on a client device.

FIG. 1B is a block diagram of the components of the client device.

FIG. 2 is a block diagram of server components that generates high complexity computer graphics and sends the graphics to a remote display device.

FIG. 3 is a block diagram of a method for streaming multi-media to a client device.

FIG. 4 is a block diagram of another method for streaming multi-media to a client device.

### SUMMARY OF THE INVENTION

In one aspect of the invention a system for real-time streaming of multi-media consists of a client device that is coupled to a network and a server. The client device is configured to receive reformatted and compressed frame data from an application that is running on a server. The server executes an application in an operating environment that appears that the rendered graphic frames are displayed on a display physically attached to the server. The server writes the rendered frames into a buffer, reformats the frame to be compatible with the client display size, compresses the frame, and transmits the frame to the client.

In a further embodiment, the interfaces are loaded by the application onto the server. During the loading, the server is configured for modifying the interfaces to write the rendered frames to the buffer. In some embodiments, the server is configured for varying the compression of the rendered frames in response to the changes in a transmission bandwidth between the client and the server.

In another embodiment, the server is configured for capturing and buffering audio generated by the application utilizing the interface. The interface is modified to buffer the audio, transcode it to be compatible with the client's audio capabilities, compress the audio, and transmit it to the client. In come embodiments, the interface is DirectX 9, DirectX 10, or DirectX 11, Open GL or a combination thereof. The frame resizing and compression can be performed by an ITU-T H.264 codec. The audio compression can be performed by a CELT (Constrained Energy Lapsed Transform) codec.

In one embodiment, the client is configured for scaling the user inputs from the client device to match the range and type of user inputs expected by the application.

In another aspect of the invention, a method for streaming computer multi-media is disclosed. A computer graphics video frame is generated at a frame rate. The frames are generated by software calls to a multi-media API (application programming interface). This API can include DirectX 9, DirectX 10, or DirectX 11, Open GL or a combination thereof.

Each rendered frame is stored in a buffer. The buffered frame is resized into fit the client device's screen pixel width and height. The resized frame is compress by an amount that allows for a specified frame rate to be transmitted over a connection between the client and server.

In one embodiment, the frame buffering function is implemented by a modification to an API as the application loads the API on the server. The modified API writes the frame into a buffer and optionally to the server's display driver. In another embodiment, a process or thread makes a request to the operating system for a screen print of the rendered frame. The request for screen prints is made at a specified frame rate. Each screen print is stored in the buffer which is resized and compressed. The interface can be DirectX 9, DirectX 10, DirectX 11 or OpenGL. The step of resizing and compressing the frame can be based on the ITU-T H.264 standard.

Another embodiment can include the step of generating audio data through calls to the multi-media API. The generated data is buffered, processed to match the audio capabilities of the client, and compressed. The compression is selected such that the combined bandwidth of the compressed frames and compressed audio is less than a network transmission rate. The audio compress can use a CELT codec.

### DETAILED DESCRIPTION OF THE INVENTION

The following description of the invention is provided as an enabling teaching of the invention. Those skilled in the relevant art will recognize that many changes can be made to the embodiment described, while still attaining the beneficial results of the present invention. It will also be apparent that some of the desired benefits of the present invention can be attained by selecting some of the features of the present invention without utilizing other features. Accordingly, those skilled in the art will recognize that many modifications and adaptations to the present invention are possible and can even be desirable in certain circumstances, and are a part of the present invention. Thus, the following description is provided as illustrative of the principles of the present invention and not a limitation thereof.

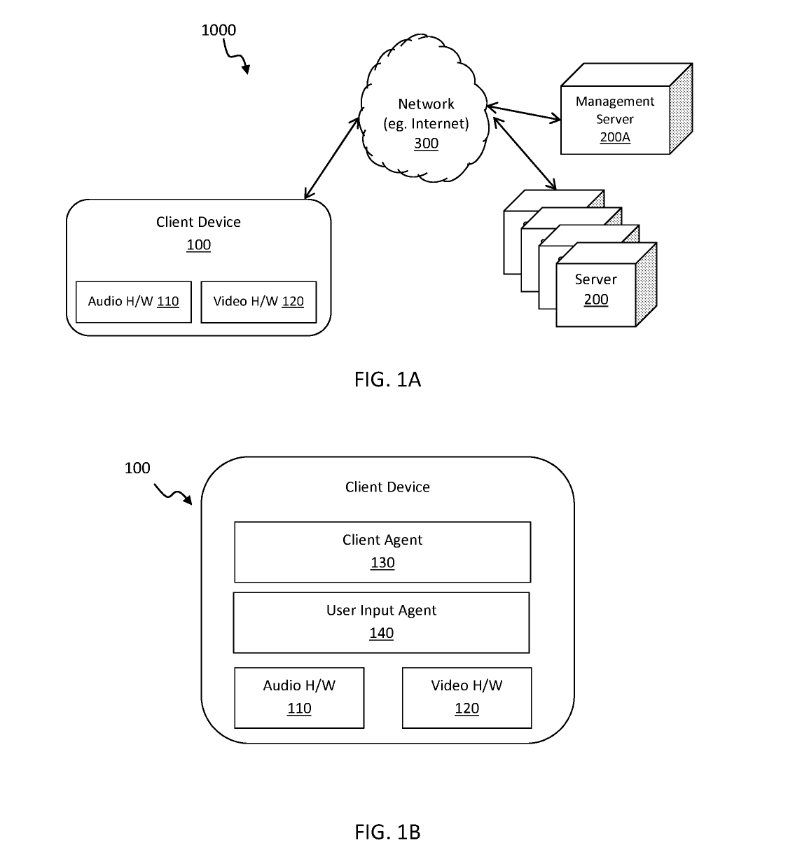

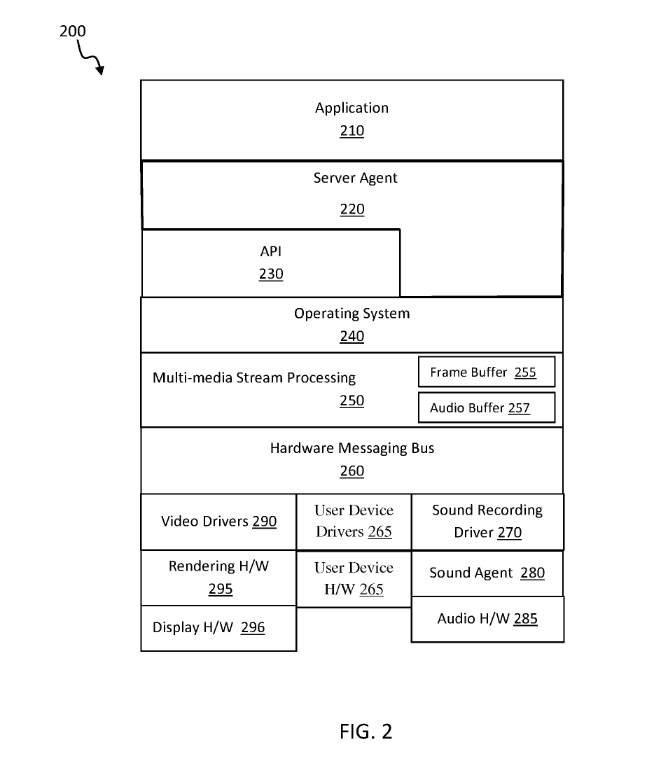

FIG. 1A is exemplar of a system 1000 for displaying graphically rendered video frames and outputting audio on a network coupled client device 100. The video and audio are generated on a server 200 by a software application 210-FIG. 2 that is designed to run in an integrated hardware environment with physically coupled user input devices, and display components and audio components. Exemplar software applications include computer games, and flight simulators. Exemplar of such integrated hardware environments is a server 200 but can include PCs (personal computers), laptops, workstations, and gaming systems.

The software application 210 is designed to have an execution environment where the video and audio is generated by system calls to standard multi-media APIs (Application Programming Interfaces). The video and audio are output on devices and sound cards physically attached to the computer. Further, the executing applications 210-FIG. 2 utilize operating system features for receiving user inputs from physically attached keyboards and pointing devices such as a mouse or trackball.

In the system for one embodiment of the invention, the API functions are modified on loading into the server to redirect or copy the rendered video frames and optionally the audio to a buffer for processing and forwarding to the client device 100. Further, hooks are configured into the operating system to inject user inputs from the client 100 so that these user input appear to the application software as if they are generated by physically attached hardware.

The system 1000 is configured for sending rendered video frames through a network 300 to the client device 100 in a format compatible with a client agent process 130. Additionally, the audio is formatted to be compatible with the client agent process 130. The system 1000 is also configured for user inputs to be generated by the client device 100 and to be injected into the server's 200 operating system in a manner that the application sees these inputs as coming from physically attached hardware.

There are a number of advantages of this architecture over integrated standalone systems. For best application performance a standalone systems requires high performance CPU's, multicore graphic processors, and large amounts of memory. The resulting trade-off is that is that a standalone system is power hungry, costly, difficult to economically share between multiple users, are typically larger and heavier, all of which limits mobility. By dividing the processing between a sharable high performance graphics processing server 200, and sending the rendered graphic frames and audio to a client device 100 a beneficial system balance is achieved. Graphic intensive software applications can run in high performance server hardware while the resulting video frames images are displayed on a wider variety of client devices including but not limited to mobile phones, tablets, PCs, set-top boxes, and in-flight entertainment systems. The expensive hardware components can be shared without reducing mobility. Applications that have not been ported to a mobile device or would not be able to run on a mobile device due to memory or processing requirements can be now be utilized by these client devices with only a port of client components. Further, new models of renting applications or digital rights management can be implemented.

The server 200 comprises high-performance hardware and software needed to provide real-time graphics rendering for graphics intensive applications.

The server 200 is configured for executing application software 210 in a system environment that appears as if it is executing in a hardware environment with an integrated display 296 and audio hardware 285 to which the generated video and audio is output. This hardware is not required but preferably is present. The server 200 captures or copies the rendered graphic frames and generates new graphic images compatible with the display device 100 and the communication bandwidth between the server and client. This processing can include resizing and compressing the frames and configuring the data into a format required by the client agent 130-FIG. 1B. The execution environment may indicated to the application 210 a physical display 296 resolution different than the client's 120 display resolution. Also, the client device 100 can have different audio capabilities from what is generated by the application software 210. The application software 210 may generate multiple channels of sound intended for a multi-speakers configuration whereas the client device 100 may have only one or two channels of audio outputs.

Thus, the server 200 buffers the video 255 and buffers audio data 257, resizes the video and audio data to be compatible with the client device 100, and compresses the data to match the available bandwidth between the server 200 and client 100.

The server 200 can be part of a server farm containing multiple servers. These servers can include servers for system management. The servers 200 can be configured as a shared resource for a plurality of client devices 100.

The elements of the server 200 are configured for providing a standardized and expected execution environment for the application 210. For example, the standardized application 210 might be configured for running on a PC (personal computer) that has known graphic and audio API 230 for generating graphic frames and audio. The application 210 can be configured for using this API interface 230 and to receive input from the PC associated keyboard and mouse. The server 200 is configured for mimicking this environment and to send the rendered graphics frame and audio to the network coupled client device 100. User inputs are generated and transmitted from the client device 100 as opposed or in addition to a physically coupled user device 267.

The network 300 is comprised of any global or private packet network or telecom network including but not limited to the Internet and cellular and telephone networks, and access equipment including but not limited to wireless routers. Preferably the global network is the Internet and cellular network running standard protocols including but not limited to TCP, UDP, and IP. The cellular network can include cellular 3G and 4G networks, satellite networks, cable networks, associated optical fiber networks and protocols, or any combination of these networks and protocols required to transport the process video and audio data.

The client device 100 is coupled to the network 300 either by a wired connection or a wireless connection. Preferably the connection is broadband and has sufficient bandwidth the support real-time video and audio without requiring compression to a degree that excessively degrades the image and audio quality.

Referring to FIG. 1B, the client device 100 the components of a client device 100 include a client agent 130, and client user interface 120, client audio hardware 110 and associated drivers, and the client video hardware 120 that includes the display and driver electronics and software.

The client agent 130 is configured for receiving, uncompressing, and displaying the compressed reformatted video frames and optionally audio data sent by the server 200. Preferably, the client has a ITU-T H.264 codec for decoding the video frames.

The client interface 140 component provides a user interfaces for interacting with the server manager 200A and generating user inputs for the application 210-FIG. 2. For devices without a keyboard or mouse, the client interface component 140 can provide a graphical overlay of a keyboard on a touch sensitive display. Another exemplar function of this component 140 is to convert taps on the touch sensitive display into clicks on the mouse. Another function of the client interface 140 component is to scale the user inputs to match the range of user inputs expected by the application 210-FIG. 2. Exemplar of this would be for a client device having a pixel coordinates that range from (0,0) to (1080, 786) but the server application 210 is rendering frames for a display configured for (0,0) to (1680, 1050) pixels. Thus, for the user inputs on the client device 100 generate inputs for the entire display range on the server display, the client generated input need to be scaled to cover the entire range of server display coordinates.

Preferably the client device 100 uses standard Internet protocols for communication between the client device 100 and the server 200. Preferably, three ports are used in the connection between the client 100 and server 200. Preferably the video and audio is sent using UDP tunneling through TCP/IP or alternatively by HTTP but other protocols are contemplated. Also, the protocol is RTSP (Real Time Streaming protocol) and provided by Live555 (Open Source) is used in transporting the video and audio data.

A second port is used for control commands. Preferably the protocol is UDP and a proprietary format similar to windows message is used but other protocols are contemplated. A third port is used to for system commands. Preferably these commands are sent using a protocol that guarantees delivery. These protocols include TCP/IP but other contemplated are contemplated.

Referring to FIG. 2, is an exemplar configuration of the server 200 elements for one embodiment of the invention. In this embodiment, an application 210 is configured for generating graphic video frames though software calls to an API (application programming interface) 230 such as DirectX or Open GL. In an standard configuration (excluding the inventive element), the programming API 230 communicates with the operating system 240 that in turn communicates with the graphics drivers 290 and video hardware 295 for generating the rendered graphic frames, displaying the rendered graphics 296, and outputting application 210 generated audio to the audio hardware 285.

However in the embodiment shown in FIG. 2, the server 200 is configured for capturing the rendered video frame, generated audio, processing the audio and video to be compatible with a client device 100, and sending the process video frames and audio over a network 300 to the client device 100 for display and audio playback. Further the server in FIG. 2 is configured for receiving user inputs from the client and inserting them into the operating system environment such that they appear to be coming from physically connect user hardware.

The server is configured with an application 210. The application 210 can include any application 210 that generates a video output on the display hardware 296. The applications can include computer games but other applications are contemplated. The application 210 can upon starting load and install a multi-media API 230 onto the server 200. This API can include DirectX 9, DirectX 10, DirectX 11, or Open GL but other standard's base multi-media APIs are contemplated. Alternatively, the application 210 can bypass the API 230 and directly call video drivers to access the audio and video hardware 296, 285.

The server agent 220 element is configured for monitoring the application 210 as it loads on API, modifying the API 230 functions to store in a frame buffer 255 a copy of the rendered frame. Additionally, the server agent 220, receives user inputs from the client device 100 and inputs them into the operating system 240 or hardware messaging bus 260 in a manner to appear as if they were received from the physically attached hardware 267. Physically connected hardware 267 typically inject messages into what is referred to as a hardware messaging bus 260 on Microsoft® Windows operating systems. As user inputs are received from the client 100 the server agent 220 converts the commands into a Windows message so that the server 200 is unaware of the source. Any user input can be injected into the Windows message bus. For some applications, a conversion routine converts the Windows message into an emulated hardware message. However, other operating system and methods for inputting messages any other operating system method for handling user inputs by the operating system 240 is contemplated.

The multi-media API 230 provides a standard interface for applications to generate video frames using the server hardware 295. Preferable the multi-media API is DirectX and its versions, or Open GL. However, the invention contemplates new and other API interfaces. The API 230 can be loaded by the application or can be preinstalled into the server 200.

The server 200 is configured for an operating system 240. The operating system 240 can be any standard operating system used on servers or PC's. Preferably the operating system is one of Micrsoft's operating systems including but not limited to Windows XP, Server, Vista, and Windows 7. However, other operating systems are contemplated. The only limitation is that the application 210 needs to be compatible with the operating system 240.

The multi-media stream processing 250 element is configured for formatting each frame to be compatible with the client display 296, compressing each video frame butter 255, and sending the resized and compressed frame to the client 100. Because the application 210 can be generating graphics frames targeted to a video device 296 coupled to the server 200, the generated graphics may be different from the size, dimensions, resolution of the client device display hardware 296. For example, the application 210 could be generating graphic video frames for a display having a resolution of 1680×1050. The client device could have a different display resolution, 1080×720 for example. For the server rendered frame to be displayed on the client 100, the frame needs to be resized.

Further, to save transmission bandwidth and to match the available transmission bandwidth between the client and server, the rendered frame is compressed. A lossless or lossy compression can be used. If the bandwidth is insufficient for a lossless transmission of data, then the compression will have to be lossy. Preferable, the compression and reformatting standard ITU-T H.264 codec is used. Preferably, there is only buffering of only one frame of video. If the processed frame is not transmitted before the next frame is received, then the frame is over written. This assures that only the most recent frame is transmitted to increase the real-time response.

The server 200 can be configured with a layer 260 within the operating system that provides messaging based on the user inputs from hardware devices physically connected to the server 200. The server agent 220 injects use input messages received from the client 100 into the hardware messaging buss 260 so that user input originating from the client 100 appears as input from a physically connected device 267.

The server 200 is configured with video drivers 290 and rendering hardware 295 for generating and displaying video frames on the server. The video driver 290 is a standard driver for the frame rendering hardware 295. The server 200 can have display hardware 296 attached to it.

The multi-media stream processing 250 can include processing an audio buffer 257. The audio or a copy of the audio is buffered. Preferably, the size of the audio buffer 257 is the same as the frame rate so that the audio and frames can be in sync. The buffered audio 257, if needed, is modified to match the audio capability of the client device 100 and the audio is compressed, preferable with a low delay algorithm. Preferably, a CELT codec is used for compression.

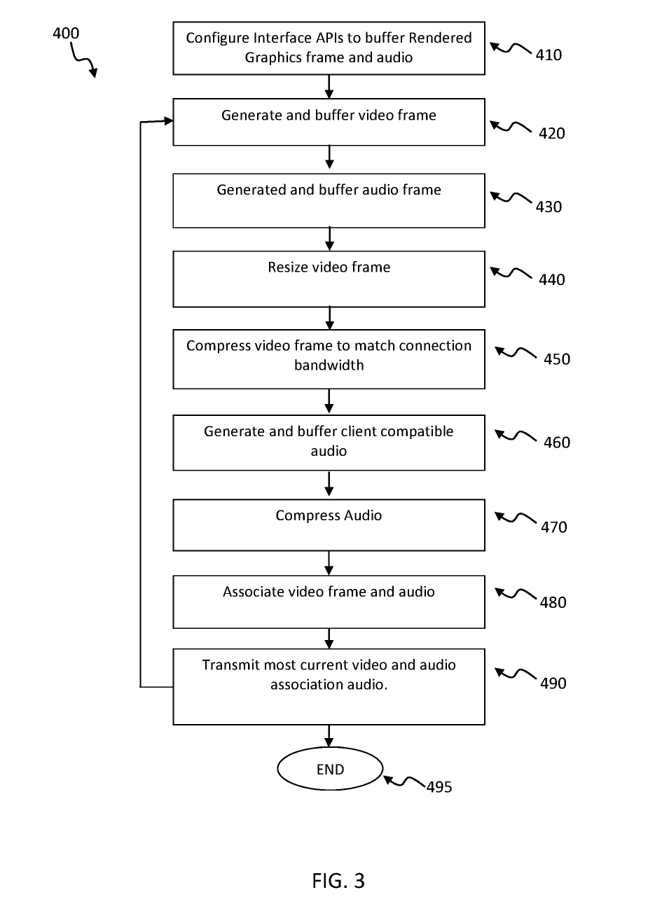

Referring to FIG. 3, another inventive embodiment is shown. A process diagram for real-time streaming of computer graphics video to a client device is shown and described. Some of the steps described are optional.

In a step 410, the API is modified or replaced so that the rendered graphics video frame, resulting from application calls to the API are sent to a buffer for further processing. Additionally, the API is used to generate sound and can be modified or replaced so that the audio can be buffered and further processed. The step 410 can occur when the application starts if the application loads the API into the server. Alternatively, if the API is part of the operating system, it can be modified upon server startup or before startup.

In a step 420, a call to an API by an application generates a graphic video frame. The video frame is stored in a buffer as a result of the functionally modified API. Each new frame generated is stored in the same buffer. Thus, a queue of unsent frames cannot build up. If the bandwidth of a communication link between the client and server decreases, unsent frames are overwritten and the transmitted frames reflects the most recent frame.

In a step 430, a call to the API by the application generates audio. A buffer of audio information is stored for further processing. Preferably, the amount of audio data buffered corresponds to the time between frames. The audio data can come from an API modification to copy audio data to an audio buffer or can use a sound recording driver that is part of an operating system.

In a step 440, the video frame is processed to match the rendered frame dimensions with the display size of the client device. This can be implemented by pixel interpellation and down sampling but other methods are contemplated. Alternatively the resizing of the frame can be part of a video codec including but not limited to ITU-T H.264 codec.

In a step 450 the resized video frame is compressed. The compression can be lossless or lossy. The amount of compression is determined by the available bandwidth for transmission. The compression is set to be less than the available bandwidth and leaving enough extra transmission bandwidth to allow for the transmission of audio data.

In a step 460, the buffered audio data is processed to be compatible with a client agent. This can include transformation of the audio data from many channels to one or two channels.

In a step 470, the processed audio buffer is compressed. A low delay compression algorithm is preferable. The CELT codec is exemplar of a low delay codec but others are contemplated.

In a step 480, the compressed and reformatted video frame buffer is associated with the compressed audio buffer.

In a step 490, the most recent compressed audio and video data is transmitted to the client device. Preferably, the data is transmitted together to keep the audio and video in sync. The method is repeats starting at step 420 until the process exits.

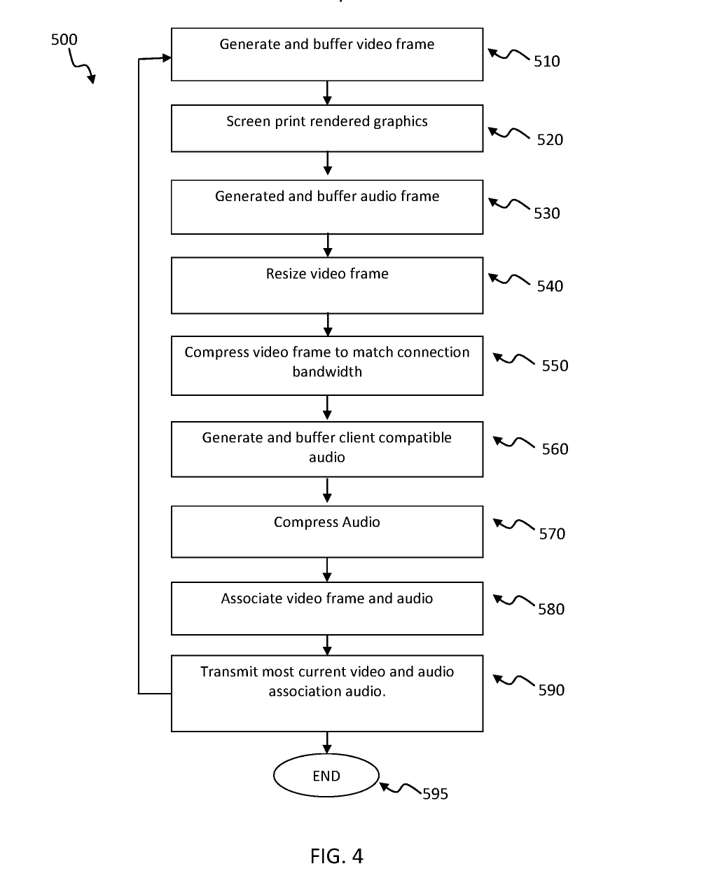

Referring to FIG. 4, another inventive embodiment of the steps for a process 500 for streaming multi-media between a server 200 and a client 100 is shown. Some of the steps described are optional.

In a step 510 a video frame for display is generated. An application communicates directly the graphics rendering hardware 295 and video drivers 290 to generate a frame of data. An operating system function is called to snapshot a screen frame of rendered data. For the Windows operating system, this function is the print screen function. The returned video frame is stored in a buffer for processing.

Steps 530-590 are identical to the functions performed for steps 430-490 FIG. 3.

### Operational Example

In operation, first a connection between a client device and a graphic rendering server is set up. The connection is setup by both the client device and the rendering server connecting to a URL (uniform resource locator) management server over the Internet. The URL management server receives a public IP and port address from each rendering server that connects to it. The IP and port address from this server and other servers are managed as a pooled resource. An IP and port address for an available rendering server is passed to the client device.

The rendering server can have multiple applications configured within it. A menu of applications can be sent to the client for user selection. A client agent, a thread or process, manages the menu. Upon user selection, a message is sent to the server to start the application. The application then begins execution on the rendering server.

The rendering server is configured for applications that require physically connected hardware display devices and user input devices to execute on the rendering server even though the user input is generated by a client device and the rendered graphic frames are sent and displayed on the client device. The rendered graphic frame can also be sent to the server's device driver and displayed on physically connected hardware. Where the execution environment on the server indicates that the rendered graphics are being output to a physically connected monitor, in fact a reformatted version of the video frames are sent and output on a client device. Additionally where the application is configured for generating audio utilizing a multimedia API and outputting the audio though a physically attached audio card, the audio is transcoded into a format decodable by the client device. The processed audio is compressed, and transmitted to the client device. Thus, audio generated for five channel surround sound can be output on a client device having only one or two audio channels.

The client device is configured with a user interface and client software that mimics the expected user input for the executing application. For client devices, such as tablets or smart phones that don't have a keyboard or mouse, this user interface can include a graphical overlay of a keyboard, or the use of the touch display to converting touch gestures into mouse movements and mouse clicks. Further, the client device rescales the touch inputs to match the client display size and resolution with the application's expected or assumed display size and resolution.

The server is configured for modifying, during the loading or after loading, the multimedia API software to redirect or copy each rendered frame to a buffer. The reconfiguration can be done by dynamically monitoring any API that is loaded for execution by the application upon starting. For example the loading a DLL (dynamically linked library) DirectX API contains a function pointer for what to do with the rendered frame. Where before the rendered frame is sent to a video driver for display on an attached monitor, this function pointer is modified to point at a new function that writes the rendered frame into a buffer and can also be written to the server's video driver. Also, the server can be reconfigured during or after booting if the multimedia API that is part of the loaded operating system.

If the application does not use an API to render frames, then modify the APIs cannot be used to capture frames of rendered data. Alternatively, the server agent can make calls for screen shots of the rendered frames from the operating system. The screen shots contain a buffer of the rendered frame. These calls can be made at a frame rate to keep the audio and video synced.

After writing the rendered graphics frame to the buffer, the frame needs to be processed to account for any difference between the screen resolution of the client and the resolution at which the application software is operating. This processing can include down sampling, up-sampling and pixel interpellation or any other resolution scaling methods. Further, to match the transmission bandwidth between the client and the server, the rendered and resized frame is compressed. Some video codecs both compress and resize to new screen resolutions. One video compression codec that provides these functions is H.264.

Additionally, the application can require a multi-channel audio capability. A stream of multiple channels of digital sound can be generated through calls to a standardized multi-media API. These API's can include DirectX 9, 10 or Open GL. Again, the API's are configured on either loading or on the server startup to redirect or make a copy of the audio data to a buffer for processing and transmitting to the client device. Like the rendered graphic frames, the audio is compressed to conserve bandwidth. Any audio compression algorithm can be used but low delay transforms are preferred. Preferably, CELT (Constrained Energy Lapsed Transform) audio codec is used due to its low delay.

If changes in the available transmission rate cause a frame not to be transmitted, then the frame is overwritten with the latest frame and the processed frame and processed audio replaced by the latest frame and audio. By doing so, the real-time responsiveness of the client is maintained as much as possible. The server can increase or decrease compression as the transmission bandwidth between the server and client changes.

To make sure that the audio and video frames are in sequence, the audio data is tied or mixed with the video frame data. If a video frame is over written due to delays, so is the audio data.

While executing, the client device will be receiving user input to interact with the application. These inputs are sent to a process or thread within the server. This tread or process will hook into the operating system and format the user inputs such that when the application receives the user input, it appears to have originated from a physically connected device.

What is claimed is:

1. A system for real-time streaming computer multi-media comprising;
a network coupled client device having a display resolution and an audio output, wherein the client device is configured for receiving and displaying compressed graphic video frames and transmit user inputs; and
one or more graphic rendering servers configured for rendering graphics with calls to a multimedia application programming interface, wherein the servers are configured for an application to render graphic video frames through software calls to the interface, wherein the server is configured for buffering a most recent rendered frame, and wherein the server is configured for forming a processed frame the where processed frame matches the display resolution and is compress to match a current network data transmission rate between the client device and the server.

2. The system of claim 1 wherein the server is configured for modifying the interface to buffer the most recent rendered frame.

3. The system of claim 2 wherein the server is configured for modifying the interface upon the loading into the server.

4. The system of claim 1 wherein the server is configured for varying the compression to match the current data transmission rate.

5. The system of claim 1 wherein the server is further configured for generating digital audio data through calls to the interface, configured for redirecting or copying the audio data to a buffer, compressing the audio data, configured for associating the audio data with the processed frame and transmitting the audio data to the client device.

6. The system of claim 5 wherein the interface is DirectX, Direct3D 9Ex, Direct3D 10, or Direct3D 11, Open GL or a combination thereof.

7. The system of claim 5, wherein the audio compression used a CELT codec and the frame processing uses H.264 compression codec.

8. The system of claim 5, wherein the client is configured for scaling user input to a range matching an application user input range.

9. A method for streaming computer multi-media comprising;
generating computer graphics video frame at a frame rate, wherein the frame is generated by software calls to a multimedia application programming interface;
storing the frame in a buffer;
reprocessing the frame to match a client device display form a; and
compressing the frame into a processed frame, wherein the processed frame has an average frame size and wherein the compression is selected such that the product of the average frame size with the frame rate is less than a network transmission rate.

10. The method of claim 9 further comprising a step of modifying the multimedia application programming interface to buffer the frame, wherein the interface is modified when the API loaded into a computer by an application.

11. The method of claim 9 wherein the system is configure for an operating system call for obtaining a copy of the rendered frame being displayed on the server's display.

12. The method of claim 10, wherein the compression is based on the H.261 compression standard.

13. The method of claim 10 wherein the interface is DirectX 9, DirectX 10, or OpenGL.

14. The method of claim 10 further comprising the steps of:
generating audio data, wherein the audio data is generated by software calls to the multimedia application programming interface,
storing the audio data in a buffer,
reprocessing the audio data to be compatible with an client device audio codec, and
compressing the audio data, wherein the compressed audio data has an audio data rate, and wherein the audio compression is selected where the sum of the audio data rate and the product of the average frame size with the frame rate is less than the network transmission rate.

15. The method of claim 14 wherein the compressing the audio data is done with a CELT codec.

16. The method of claim 14 further comprising the step of scaling client user inputs with application display ranges.
